(19) United States
(12) Patent Application Publication
(10) Pub. No.: US 2026/0280774 A1
(43) Pub. Date: Sep. 17, 2026

(54) DEVICES, METHODS, APPARATUSES AND COMPUTER-READABLE MEDIUM FOR COMMUNICATION

(71) Applicant: Nokia Technologies Oy, Espoo (FI)

(72) Inventors: Alessio MARCONE, Munich (DE); Frank FREDERIKSEN, Klarup (DK); Arman AHMADZADEH, Munich (DE); Ping YUAN, Beijing (CN); Bo BI, Zhejiang (CN)

(21) Appl. No.: 19/471,019

(22) PCT Filed: Apr. 6, 2023
(86) PCT No.: PCT/CN2023/086692

§ 371 Date: Sep. 30, 2025

(51) Int. Cl. H04L 1/1829; H04W 74/0833; H04W 84/06

(52) U.S. Cl. CPC H04L 1/1829; H04W 74/0833; H04W 84/06

(57) ABSTRACT

Example embodiments of the present disclosure relate to a terminal device, a network device, methods, apparatuses and a computer-readable medium for communication. In an example method, a terminal device transmits a Message 3 (Msg3) message comprising a common control channel (CCCH) message to a network device. At least one spare bit in a radio resource control (RRC) message in the CCCH message is used for indicating information related to physical uplink control channel (PUCCH) repetitions for Message 4 (Msg4) hybrid automatic repeat request-acknowledgement (HARQ-ACK). In this way, communication performance can be improved.

### FIELD

Example embodiments of the present disclosure generally relate to the field of telecommunication, and in particular, to a terminal device, a network device, methods, apparatuses, and a computer-readable medium for communication.

### BACKGROUND

Because the existing 3GPP (3rd generation partnership project) Release-17 (Rel-17) specification cannot meet the performance requirement, support for physical uplink control channel (PUCCH) repetitions for message 4 (Msg4) hybrid automatic repeat request—acknowledgement (HARQ-ACK) attracts much attention and is under intense study.

Different methods are proposed for indication of the user equipment (UE) capability or request of performing PUCCH repetitions for Msg4 HARQ-ACK. However, indication via physical random access channel (PRACH) resources is very expensive. Indication via Msg3 message can be done via either higher layer or physical layer signalling. The former solution repurposes the reserved bits in the medium access control (MAC) subheader of the Msg3 message or defines new logical channel identifier (LCID) states indicating UE capability or request, hence the reserved bits are always there, so a UE always reports the capability or request, even when the gNB is already aware of UE's capabilities. The latter solution defines up to 4 new LCID states to support both reduced capability (RedCap) UEs and non-RedCap UEs, making it very expensive for the system.

### SUMMARY

In general, example embodiments of the present disclosure provide a terminal device, a network device, methods, devices, and a computer-readable medium for communication, for example, to indicate PUCCH repetition capability via spare bit(s) in a Msg3 message.

In a first aspect, there is provided a terminal device. The terminal device comprises at least one processor and at least one memory storing instructions that, when executed by the at least one processor, cause the terminal device at least to: transmit, to a network device, a Msg3 message comprising a common control channel (CCCH) message, wherein at least one spare bit in a radio resource control (RRC) message in the CCCH message is used for indicating information related to PUCCH repetitions for Msg4 HARQ-ACK.

In a second aspect, there is provided a network device. The network device comprises at least one processor and at least one memory storing instructions that, when executed by the at least one processor, cause the network device at least to: receive, from a terminal device, a Msg3 message comprising a CCCH message, wherein at least one spare bit in an RRC message in the CCCH message is used for indicating information related to PUCCH repetitions for Msg4 HARQ-ACK.

In a third aspect, there is provided a method. The method comprises: transmitting, at a terminal device and to a network device, a Msg3 message comprising a CCCH message or, wherein at least one spare bit in an RRC message in the CCCH message is used for indicating information related to PUCCH repetitions for Msg4 HARQ-ACK.

In a fourth aspect, there is provided a method. The method comprises: receiving, at a network device and from a terminal device, a Msg3 message comprising a CCCH message, wherein at least one spare bit in an RRC message in the CCCH message is used for indicating information related to PUCCH repetitions for Msg4 HARQ-ACK.

In a fifth aspect, there is provided an apparatus. The apparatus comprises: means for transmitting a Msg3 message comprising a CCCH message, wherein at least one spare bit in an RRC message in the CCCH message is used for indicating information related to PUCCH repetitions for Msg4 HARQ-ACK.

In a sixth aspect, there is provided an apparatus. The apparatus comprises: means for receiving a Msg3 message comprising a CCCH message, wherein at least one spare bit in an RRC message in the CCCH message is used for indicating information related to PUCCH repetitions for Msg4 HARQ-ACK.

In a seventh aspect, there is provided a non-transitory computer-readable storage medium having instructions stored thereon. The instructions, when executed on at least one processor, cause the at least one processor to perform the method of any of the third or fourth aspects.

In an eighth aspect, there is provided a computer program comprising instructions, which, when executed by an apparatus, cause the apparatus at least to: transmit, to a network device, a Msg3 message comprising a CCCH message, wherein at least one spare bit in an RRC message in the CCCH message is used for indicating information related to PUCCH repetitions for Msg4 HARQ-ACK.

In a ninth aspect, there is provided a computer program comprising instructions, which, when executed by an apparatus, cause the apparatus at least to: receive, from a terminal device, a Msg3 message comprising a CCCH message, wherein at least one spare bit in an RRC message in the CCCH message is used for indicating information related to (PUCCH repetitions for Msg4 HARQ-ACK.

In a tenth aspect, there is provided a terminal device according to the first aspect. The terminal device comprises: transmitting circuitry configured to transmit, to a network device, a Msg3 message comprising a CCCH message, wherein at least one spare bit in an RRC message in the CCCH message is used for indicating information related to PUCCH repetitions for Msg4 HARQ-ACK.

In an eleventh aspect, there is provided a network device according to the second aspect. The network device comprises: receiving circuitry configured to receive, from a terminal device, a Msg3 message comprising a CCCH message, wherein at least one spare bit in an RRC message in the CCCH message is used for indicating information related to PUCCH repetitions for Msg4 HARQ-ACK.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of a network environment in which some example embodiments of the present disclosure may be implemented;

FIG. 2 illustrates a signaling chart illustrating an example communication process in accordance with some example embodiments of the present disclosure;

FIG. 3A illustrates a schematic diagram illustrating an uplink (UL) MAC protocol data unit (PDU) in accordance with some example embodiments of the present disclosure;

FIG. 3B illustrates a schematic diagram illustrating a MAC subheader in accordance with some example embodiments of the present disclosure;

FIG. 3C illustrates a schematic diagram illustrating a UL-CCCH-Message message in accordance with some example embodiments of the present disclosure;

FIG. 3D illustrates a schematic diagram illustrating an RRCSetupRequest message in accordance with some example embodiments of the present disclosure;

FIG. 3E illustrates a schematic diagram illustrating an RRCResumeRequest message in accordance with some example embodiments of the present disclosure;

FIG. 3F illustrates a schematic diagram illustrating an RRCReestablishRequest message in accordance with some example embodiments of the present disclosure;

FIG. 3G illustrates a schematic diagram illustrating an RRCSystemInfoRequest message in accordance with some example embodiments of the present disclosure;

FIG. 3H illustrates a schematic diagram illustrating a UL-CCCH1-Message message in accordance with some example embodiments of the present disclosure;

FIG. 3I illustrates a schematic diagram illustrating an RRCResumeRequest1 message in accordance with some example embodiments of the present disclosure;

FIG. 4A illustrates a signaling chart illustrating an example communication process in accordance with some example embodiments of the present disclosure;

FIG. 4B illustrates a schematic diagram illustrating an RRCSetupRequest-IEs field with a spare bit being repurposed in accordance with some example embodiments of the present disclosure;

FIG. 5A illustrates a signaling chart illustrating another example communication process in accordance with some example embodiments of the present disclosure;

FIG. 5B illustrates a schematic diagram illustrating an RRCResumeRequest1-IEs field with a spare bit being repurposed in accordance with some example embodiments of the present disclosure;

FIG. 6A illustrates a signaling chart illustrating another example communication process in accordance with some example embodiments of the present disclosure;

FIG. 6B illustrates a schematic diagram illustrating a ReestablishmentCause field with a spare state being repurposed in accordance with some example embodiments of the present disclosure;

FIG. 7 illustrates a flowchart of an example method implemented at a terminal device in accordance with some embodiments of the present disclosure;

FIG. 8 illustrates another flowchart of an example method implemented at a network device in accordance with some embodiments of the present disclosure;

FIG. 9 illustrates a simplified block diagram of a device that is suitable for implementing some example embodiments of the present disclosure; and

FIG. 10 illustrates a block diagram of an example of a computer-readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Wireless Fidelity (WiFi) and so on. Furthermore, the communications between a terminal device and a network device in the communication network may be performed according to any suitable generation communication protocols, including, but not limited to, the fourth generation (4G), 4.5G, the future fifth generation (5G), IEEE 802.11 communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a WiFi device, a relay, a low power node such as a femto, a pico, and so forth, depending on the applied terminology and technology. In the following description, the terms “network device”, “AP device”, “AP” and “access point” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a station (STA) or station device, or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a VR (virtual reality) device, an XR (extended reality) device, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “station”, “station device”, “STA”, “terminal device”, “communication device”, “terminal”, “user equipment” and “UE” may be used interchangeably.

The Rel-18, non-terrestrial network (NTN) objectives are focused on the applicability of the solutions developed by general new radio (NR) coverage enhancement to NTN. Considering the NTN involving large propagation delay and satellite movement, it is necessary to identify potential issues and enhancements.

In 3GPP TSG RAN WG1 #110, RAN1 agreed that PUCCH for Msg4 HARQ-ACK should be enhanced to meet the coverage requirements for parameter set-1 for low earth orbit (LEO)-1200 operating at line of sight (LOS), assuming −5 dBi UE antenna gain, because the existing Release-17 specification cannot meet the performance requirement with a gap of 1.8 to 6 dB.

In 3GPP TSG RAN WG1 #110bis-e, RAN1 agreed that Release-18 should support PUCCH repetition for Msg4 HARQ-ACK. In 3GPP TSG RAN WG1 #111, RAN1 agreed that one or more repetition factors may be configured via system information block (SIB) for PUCCH for Msg4 HARQ-ACK and if multiple factors from {1, 2, 4, 8} are configured via SIB, PUCCH repetition for Msg4 HARQ-ACK may be dynamically determined and indicated by gNB. In 3GPP TSG RAN WG1 #112, RAN1 agreed that UE should indicate capability for PUCCH repetitions for Msg4 HARQ-ACK and agreed on dynamic indication of repetition factor from gNB.

A solution for indication of the UE capability or request of performing PUCCH repetitions for Msg4 HARQ-ACK is necessary to make sure gNB is aware of the UE capability or request before scheduling a number of PUCCH repetitions for the Msg4 HARQ-ACK. Different methods are possible for indication of such capability or request from the UE, each having their advantages and disadvantages from a system perspective point of view.

In one example, such indication may be implemented via PRACH resources. However, indication via PRACH resources is very expensive considering the different features that currently utilize such mechanism, and using PRACH resources for indication of PUCCH repetition capability or request introduces further segmentation/fragmentation to PRACH resources, increasing the collision probability within each segment/fragments, as it is impossible for the gNB to know the required PRACH capacity for each segment/fragment. This is undesirable in general and especially in an NTN scenario characterized by large propagation delays.

In another example, such indication may be implemented via higher layer signalling or physical layer signalling. For solutions via higher layer signalling, two directions were proposed: repurpose the reserved bits in the MAC subheader of the Msg3 message or define new LCID states indicating not only the size (48 and 64 bits) of CCCH message in the Msg3 message but also UE capability or a request for PUCCH repetitions for Msg4 HARQ-ACK or a request of a number of PUCCH repetitions for Msg4 HARQ-ACK. The latter solution has the drawback that up to 4 new LCID states will have to be defined (using the current reserved LCID states) to support both RedCap UEs and non-RedCap UEs, making it very expensive for the system as it would leave only few available reserved states for future applications. The former solution has the drawback that the “R” (reserved) bits are always there, and so a UE would always report the capability or request, even when a UE is already in RRC connected mode and has a dedicated PUCCH resource configuration, and hence gNB is already aware of its capabilities.

In order to improve the communication performance between the UE and the network device, methods for reporting UE capability or performing a request for PUCCH repetitions for Msg4 HARQ-ACK or performing a request of a number of PUCCH repetitions for Msg4 HARQ-ACK via higher layer signaling in Msg3 message are proposed in this disclosure. According to this disclosure, the terminal device transmits a Msg3 message comprising a CCCH message to the network device, and at least one spare bit in an RRC message in the CCCH message is used for indicating information related to PUCCH repetitions for Msg4 HARQ-ACK. In this way, communication performance between the terminal device and the network device can be improved.

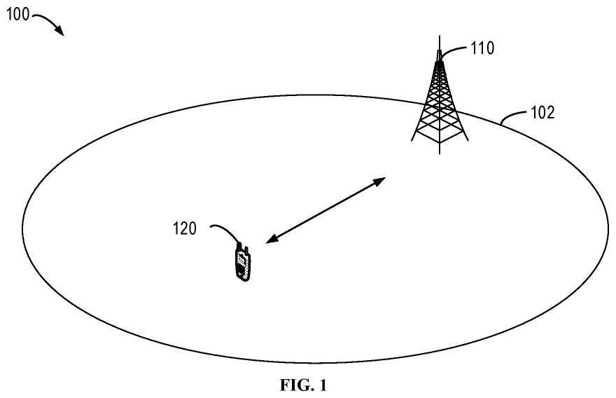

FIG. 1 illustrates an example of a network environment 100 in which some example embodiments of the present disclosure may be implemented. In the descriptions of the example embodiments of the present disclosure, the network environment 100 may also be referred to as a communication system 100 (for example, a portion of a communication network). For illustrative purposes only, various aspects of example embodiments will be described in the context of one or more terminal devices and network devices (which can also be referred to as “network node” in this disclosure) that communicate with one another. It should be appreciated, however, that the description herein may be applicable to other types of apparatus or other similar apparatuses that are referenced using other terminology.

In the communication system 100, the network device 110 can provide services to the terminal device 120, and the network device 110 and the terminal device 120 may communicate data and control information with each other. In some embodiments, the network device 110 and the terminal device 120 may communicate with direct links/channels.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1, the network device 110 provides one serving cell 102, and the terminal device 120 camps on the serving cell 102. In some embodiments, the network device 110 can provide multiple serving cells. It is to be understood that the number of serving cell(s) shown in FIG. 1 is for illustrative purposes without suggesting any limitation.

Communications in the network environment 100 may be implemented according to any proper communication protocol(s), comprising, but not limited to, cellular communication protocols of the fourth generation (4G) and the fifth generation (5G), including non-terrestrial network (NTN), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Thought the network device 110 is illustrated as on the ground, in some example embodiments, the network environment 100 may be a part of a non-terrestrial network (NTN). In such a case, the network environment 100 may further comprise a satellite, and the network device 110 may operate in a transparent mode, which means, it forwards a signaling (or in other words, a message) between the terminal device 120 and the satellite without decoding the signaling. In some other example embodiments, the network device 110 may be implemented in a satellite and operate in a regenerative mode. In other words, in such a case, the network device 110 may decode a signaling (i.e., a message) between the terminal device 120 and the satellite.

It is to be understood that the number of devices and their connection relationships and types shown in FIG. 1 are for illustrative purposes without suggesting any limitation. The communication system 100 may comprise any suitable number of devices adapted for implementing embodiments of the present disclosure.

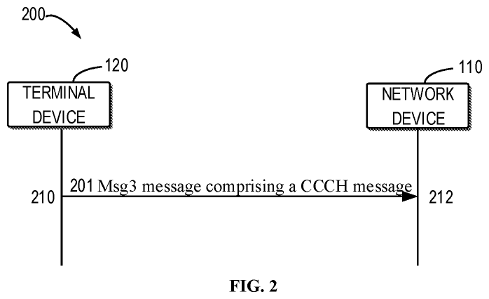

FIG. 2 illustrates a signaling chart illustrating an example communication process 200 in accordance with some example embodiments of the present disclosure. For the purpose of discussion, the communication process 200 will be described with reference to FIG. 1. The communication process 200 may involve the terminal device 120 and the network device 110.

In some example embodiments, as illustrated in FIG. 2, the terminal device 120 transmits (210) a Msg3 message 201 comprising a CCCH message to the network device 110. On the other side of communication, the network device 110 receives (212) the Msg3 message 201. At least one spare bit in a RRC message in the CCCH message is used for indicating information related to PUCCH repetitions for Msg4 HARQ-ACK.

In some example embodiments, the CCCH message may comprise a UL-CCCH-Message message. Alternatively, the CCCH message may comprise a UL-CCCH1-Message message. In one example, the terminal device 120 is a normal (i.e., non-RedCap) terminal device, in which case the CCCH message comprises a UL-CCCH-Message message which in turn may comprise at least one of a RRCSetupRequest message, RRCResumeRequest message, a RRCReestablishmentRequest messae or a RRCSystemInfoRequest message. In another example, the terminal device 120 is a RedCap terminal device, in which case the CCCH message comprises a UL-CCCH1-Message message which in turn may comprise a RRCResumeRequest1 message.

In some example embodiments, the information related to PUCCH repetitions for Msg4 HARQ-ACK may comprise a capability of the terminal device for PUCCH repetitions for Msg4 HARQ-ACK. Alternatively or additionally, the information may comprise a request for PUCCH repetitions for Msg4 HARQ-ACK. Alternatively or additionally, the information may comprise a request of a number of PUCCH repetitions (or also referred to as PUCCH repetition factor) for Msg4 HARQ-ACK.

In some example embodiments, the information may comprise an indication of re-interpretation of at least one bit in the RRC message to be the at least one spare bit. In some example embodiments, the RRC message may be an RRCSetupRequest message, and the at least one bit may comprise at least one spare enumerated value of an EstablishmentCause field in the RRCSetupRequest message.

In some example embodiments, the RRC message may be an RRCReestablishmentRequest message, and the at least one bit may comprise at least one spare enumerated value of a ReestablishmentCause field in the RRCReestablishmentRequest message. In some example embodiments, a part of the information may be indicated by the at least one spare bit in the RRC message. In some example embodiments, another part of the information may be indicated by at least one “R” (reserved) bit in a medium access control (MAC) subheader in the Msg3 message 201.

In some example embodiments, before the terminal device 120 transmits (210) the Msg3 message 201, the terminal device 120 may further obtain a configuration of the at least one spare bit in the RRC message to indicate the information, and set the at least one spare bit in the RRC message based on the configuration of the at least one spare bit and the information.

In some example embodiments, before receiving the Msg3 message, the network device 110 may determine a configuration of the at least one spare bit in the RRC message to indicate the information, and transmit the configuration to the terminal device 120.

In some example embodiments, in order to obtain the configuration, the terminal device 120 may receive the configuration from the network device 110 via higher layer signaling. Alternatively, in order to obtain the configuration, the terminal device 120 may determine the configuration which is preconfigured at the terminal device 120.

In some example embodiments, the RRC message may comprise an RRCResumeRequest message. Alternatively or additionally, the RRC message may comprise an RRCResumeRequest1 message. Alternatively or additionally, the RRC message may comprise an RRCSystemInfoRequest message.

In some example embodiments, a single spare bit in an RRCSetupRequest-IEs field in an RRCSetupRequest message may be used for indicating the information. Alternatively or additionally, at least one spare state of an EstablishmentCause field in an RRCSetupRequest message may be used for indicating the information. Alternatively or additionally, a single spare bit in an RRCResumeRequest-IEs field in an RRCResumeRequest message may be used for indicating the information. Alternatively or additionally, a single spare bit in an RRCResumeRequest1-IEs field in an RRCResumeRequest1 message may be used for indicating the information.

Alternatively or additionally, a single spare bit in an RRCReestablishmentRequest-IEs field in an RRCReestablishmentRequest message may be used for indicating the information. Alternatively or additionally, at least one spare state of a ReestablishmentCause field in an RRCReestablishmentRequest message may be used for indicating the information. Alternatively or additionally, at least one spare bit in an RRCSystemInfoRequest-IEs field in an RRCSystemInfoRequest message may be used for indicating the information. Alternatively or additionally, at least one spare type in an UL-CCCH-MessageType field in an UL-CCCH1-Message message may be used for indicating the information. In some example embodiments, the at least one spare bit may be used for indicating the information when the terminal device 120 is in an NTN.

The Msg3 message is defined in standard specifications as a message transmitted on UL-SCH (MAC entity) containing a C-RNTI MAC CE or CCCH SDU, submitted from upper layer and associated with the UE Contention Resolution Identity, as part of a Random Access procedure. In initial access, UE includes the CCCH SDU in the Msg3 message containing the UE identity for requesting setup of an RRC connection to the network.

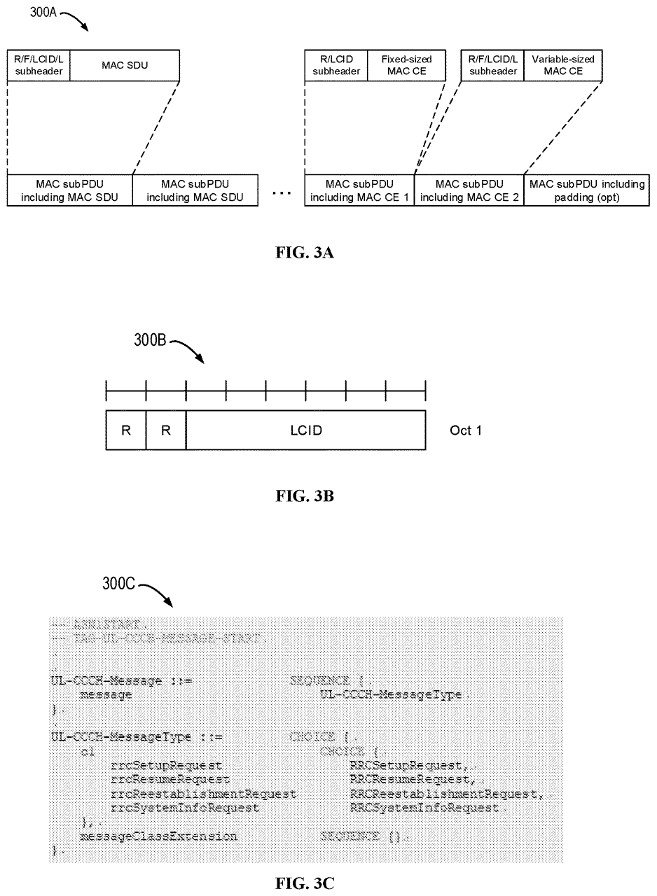

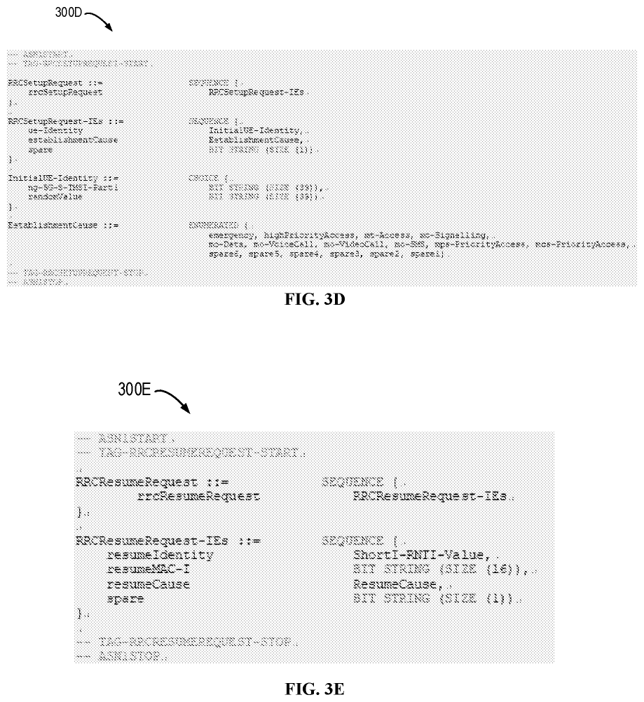

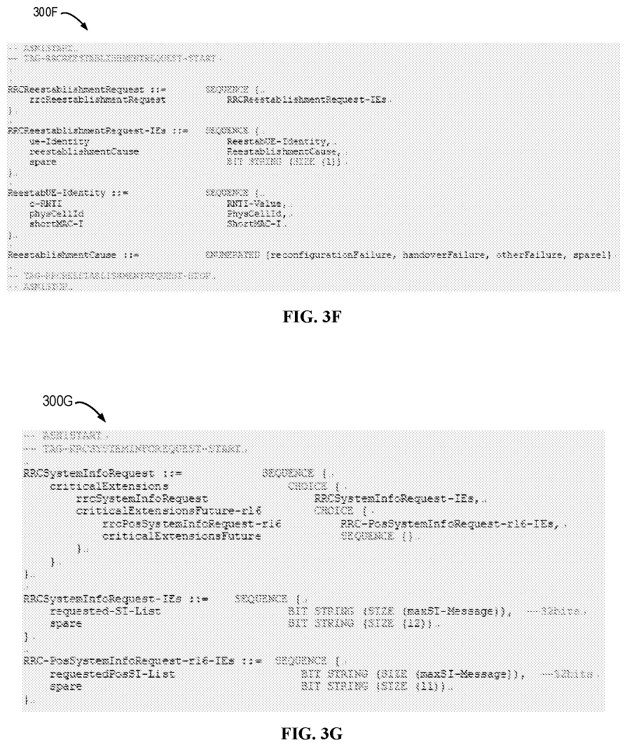

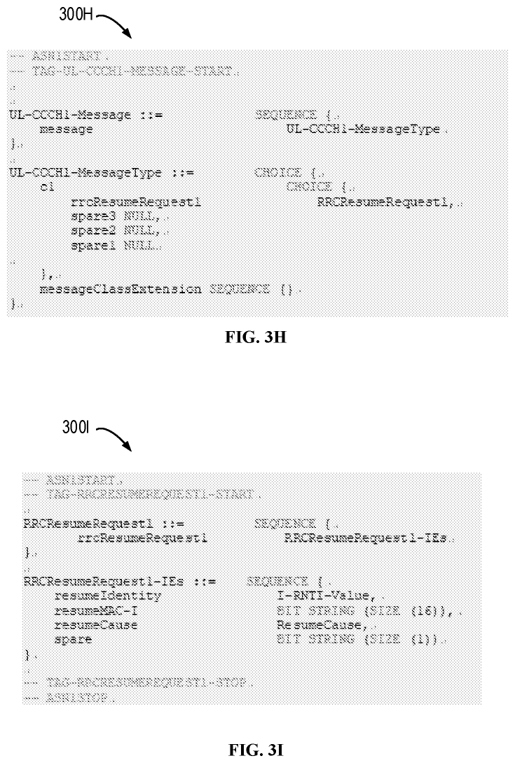

A CCCH SDU is a MAC SDU containing a CCCH message (for example, either a UL-CCCH-Message message or a UL-CCCH1-Message message), and the CCCH SDU is in turn included in a MAC PDU together with a MAC subheader. The relationship between MAC PDU and MAC SDU is illustrated in FIG. 3A. In some example embodiments, the MAC SDU includes an UL-CCCH-Message message, whose structure is illustrated in FIG. 3C which will be described later. The MAC subheader is associated with a MAC SDU containing an UL-CCCH-Message message and consists of two header fields R/LCID (which will be described later with reference to FIG. 3B). Each RRC message (e.g. rrcSetupRequest) within the UL-CCCH-Message message is of length 48 bits.

In some example embodiments, the MAC SDU includes an UL-CCCH1-Message message, whose structure is illustrated in FIG. 3H. Differently from the UL-CCCH-Message message, the UL-CCCH1-Message message is not used by the UE for requesting an RRC connection but for resuming an RRC connection, and the RRC message within the message is of length 64 bits instead of 48 bits.

FIG. 3A illustrates a schematic diagram illustrating a MAC PDU 300A in accordance with some example embodiments of the present disclosure. The MAC PDU 300A may be included in a Msg3 message as described above.

A MAC PDU is a bit string that is byte aligned (i.e. multiple of 8 bits) in length. A MAC SDU is a bit string that is byte aligned (i.e. multiple of 8 bits) in length. A MAC SDU is included into a MAC PDU from the first bit onward. A MAC CE is a bit string that is byte aligned (i.e. multiple of 8 bits) in length. A MAC subheader is a bit string that is byte aligned (i.e. multiple of 8 bits) in length. Each MAC subheader is placed immediately in front of the corresponding MAC SDU, MAC CE, or padding. As illustrated in FIG. 3A, the MAC PDU 300 may include at least one MAC subPDU including MAC SDU or MAC CE. The MAC CE may be fixed-sized or variable-sized. Optionally, the MAC PDU 300 may also include at least one MAC subPDU including padding.

Indication of UE capability or request of PUCCH repetitions for the Msg4 HARQ-ACK or request of a number of PUCCH repetitions for the Msg4 HARQ-ACK can be implemented by repurposing the spare bits in the UL-CCCH-Message message or UL-CCCH1-Message message contained in the Msg3 message, which will be described in detail with reference to FIGS. 3A to 3I.

As illustrated in FIG. 3A, the MAC subPDU may include a MAC subheader (denoted as “R/F/LCID/L subheader” in FIG. 3A) and a MAC SDU. The MAC CE may also include a MAC subheader.

FIG. 3B illustrates a schematic diagram illustrating a MAC subheader 300B in accordance with some example embodiments of the present disclosure. The MAC subheader 300B may be the MAC header as illustrated in FIG. 3A, which may be included in a MAC CE or a MAC SDU. For the purpose of discussion, the MAC subheader 300B will be described with reference to FIG. 3A.

As illustrated in FIG. 3B, each of the two “R” (reserved) fields is 1-bit long, and the “LCID” field is 6-bit long. As mentioned above, in order to support PUCCH repetition for Msg4 HARQ-ACK, indication of the UE capability or request of performing PUCCH repetitions for Msg4 HARQ-ACK is necessary. Though such indication can be implemented via higher layer to repurpose the “R” bits in the MAC subheader 300B of the Msg3 message or define new LCID states indicating UE capability or request, drawbacks may also be introduced at the same time.

Therefore, methods for reporting UE capability or performing a request of PUCCH repetitions for Msg4 HARQ-ACK or performing a request of a number of PUCCH repetitions for Msg4 HARQ-ACK via higher layer signaling in Msg3 message are proposed in this disclosure. In particular, it is proposed to use the spare bits currently present in UL-CCCH-Message message (e.g. spare bits in RRCSetupRequest message) or UL-CCCH1-Message message in the Msg3 message to indicate all or part of the information on the UE capability or request, or to indicate which other bits or fields in the UL-CCCH-Message message or UL-CCCH1-Message message contain all or part of the information on the UE capability or request. This solution has the advantage of limiting the reporting of UE capability to when UE does not have a configured dedicated PUCCH resource configuration and is requesting the setup of such RRC configuration, particularly in the case that the spare bit in RRCSetupRequest is repurposed or re-interpreted.

FIG. 3C illustrates a schematic diagram illustrating a UL-CCCH-Message message 300C in accordance with some example embodiments of the present disclosure. The UL-CCCH-Message message 300C may be included in a MAC SDU as illustrated in FIG. 3A. For the purpose of discussion, the UL-CCCH-Message message 300C will be described with reference to FIGS. 3A and 3B.

As mentioned above, it is proposed that the spare bits currently present in UL-CCCH-Message message or UL-CCCH1-Message message in the Msg3 message are used to indicate all or part of the information on the UE capability of the terminal device (for example, the terminal device 120 as illustrated in FIG. 1) or request for PUCCH repetitions for Msg4 HARQ-ACK or a request of a number of PUCCH repetitions for Msg4 HARQ-ACK. As illustrated in FIG. 3C, the UL-CCCH-Message message 300C may further include at least one of an RRCSetupRequest, an RRCResumeRequest, an RRCReestablishmentRequest, or an RRCSystemInfoRequest. Therefore, in fact, the indication of UE capability or request via UL-CCCH-Message message can be implemented with the spare bits included in at least one of the RRCSetupRequest, the RRCResumeRequest, the RRCReestablishmentRequest, or the RRCSystemInfoRequest, since such request messages are included in the UL-CCCH-Message message 300C.

FIG. 3D illustrates a schematic diagram illustrating an RRCSetupRequest message 300D in accordance with some example embodiments of the present disclosure. The RRCSetupRequest message 300D may be included in the UL-CCCH-Message message 300C as illustrated in FIG. 3C. For the purpose of discussion, the RRCSetupRequest message 300D will be described with reference to FIGS. 3A, 3B and 3C.

As illustrated in FIG. 3D, in the RRCSetupRequest 300D, there is a RRCSetupRequest-IEs field, in which a “spare” subfield is defined as 1-bit long. Under the context of this disclosure, this spare bit can be utilized for the indication for UE capability or a request for PUCCH repetitions for Msg4 HARQ-ACK or a request of a number of PUCCH repetitions for Msg4 HARQ-ACK, or to indicate that other bits or fields in, for example, the RRCSetupRequest-IEs field contain all or part of the information on the UE capability or request. As another example, the spare subfield could be used to indicate that the “R” bits in the MAC subheader are repurposed and used for indication of the UE capability.

Further, as illustrated in FIG. 3D, in the RRCSetupRequest 300D, there is also a EstablishmentCause field, which is of enumeration type, and includes several spare states, i.e., from “spare6” to “spare1”. Under the context of this disclosure, such spare states can also be utilized for the indication for UE capability or the request for PUCCH repetitions for Msg4 HARQ-ACK or the request of a number of PUCCH repetitions for Msg4 HARQ-ACK. For example, at least one bit of at least one spare state of the EstablishmentCause field can be utilized for the indication.

In some example embodiments, the single spare bit in the RRCSetupRequest-IEs field may be used to indicate that the EstablishmentCause field is to be re-interpreted. That is, the “one” spare bit in the RRCSetupRequest-IEs field indicates that coverage enhancements are activated and the EstablishmentCause field needs to be re-interpreted (with a new set of fields). In this way, the number of signaling states available for the EstablishmentCause field are potentially maintained while allowing for indication of more information via spare states (for example, the spare states as indicated by the “spare6” to “spare1” subfields in the EstablishmentCause field).

In some example embodiments, the spare bits in the subfield of the “EstablishmentCause” field may be used for concurrently indicating an EstablishmentCause (or a subset of elements in EstablishmentCause) and the capability or request of the PUCCH repetitions for Msg4 HARQ-ACK.

It may be important to notice the presence of spare bits or fields in the RRCSetupRequest-IEs field or EstablishmentCause field. The RRCSetupRequest as shown here for illustrative purpose only, spare bits in all the RRC messages in the UL-CCCH-Message message and UL-CCCH1-Message message are also can be utilized to indicate the UE capability or the request, as discussed taking the RRCSetupRequest as an example.

FIG. 3E illustrates a schematic diagram illustrating an RRCResumeRequest message 300E in accordance with some example embodiments of the present disclosure. The RRCResumeRequest message 300E may be included in the UL-CCCH-Message message 300C as illustrated in FIG. 3C. For the purpose of discussion, the RRCResumeRequest message 300E will be described with reference to FIGS. 3A, 3B and 3C.

As illustrated in FIG. 3E, in the RRCResumeRequest 300E, there is a RRCResumeRequest-IEs field, in which a “spare” subfield is defined as 1-bit long. Under the context of this disclosure, this spare bit can be utilized for the indication for UE capability or the request for PUCCH repetitions for Msg4 HARQ-ACK or a request of a number of PUCCH repetitions for Msg4 HARQ-ACK.

FIG. 3F illustrates a schematic diagram illustrating an RRCReestablishmentRequest message 300F in accordance with some example embodiments of the present disclosure. The RRCReestablishmentRequest message 300F may be included in the UL-CCCH-Message message 300C as illustrated in FIG. 3C. For the purpose of discussion, the RRCReestablishmentRequest message 300F will be described with reference to FIGS. 3A, 3B and 3C.

As illustrated in FIG. 3F, in the RRCReestablishmentRequest 300F, there is a RRCReestablishmentRequest-IEs field, in which a “spare” subfield is defined as 1-bit long. Under the context of this disclosure, this spare bit can be utilized for the indication for UE capability or a request for PUCCH repetitions for Msg4 HARQ-ACK or a request of a number of PUCCH repetitions for Msg4 HARQ-ACK.

Further, as illustrated in FIG. 3F, in the RRCReestablishmentRequest 300F, there is also a ReestablishmentCause field, which is of enumeration type, and includes a spare state, i.e., “spare1”. Under the context of this disclosure, the spare state can also be utilized for the indication for UE capability or the request for PUCCH repetitions for Msg4 HARQ-ACK or the request of a number of PUCCH repetitions for Msg4 HARQ-ACK. For example, at least one bit of the spare state “spare1” of the ReestablishmentCause field can be utilized for the indication.

FIG. 3G illustrates a schematic diagram illustrating an RRCSystemInfoRequest message 300G in accordance with some example embodiments of the present disclosure. The RRCSystemInfoRequest message 300G may be included in the UL-CCCH-Message message 300C as illustrated in FIG. 3C. For the purpose of discussion, the RRCSystemInfoRequest message 300G will be described with reference to FIGS. 3A, 3B and 3C.

As illustrated in FIG. 3G, in the RRCSystemInfoRequest 300G, there is a RRCSystemInfoRequest-IEs field, in which a “spare” subfield is defined as 12-bit long. Under the context of this disclosure, at least one spare bit in the “spare” subfield can be utilized for the indication for UE capability or a request for PUCCH repetitions for Msg4 HARQ-ACK or a request of a number of PUCCH repetitions for Msg4 HARQ-ACK.

FIG. 3H illustrates a schematic diagram illustrating a UL-CCCH1-Message message 300H in accordance with some example embodiments of the present disclosure. The UL-CCCH1-Message message 300H may be included in a MAC SDU as illustrated in FIG. 3A. For the purpose of discussion, the UL-CCCH1-Message message 300H will be described with reference to FIGS. 3A and 3B.

As mentioned above, it is proposed that the spare bits currently present in UL-CCCH1-Message message in the Msg3 message are used to indicate all or part of the information on the UE capability of the terminal device (for example, the terminal device 120 as illustrated in FIG. 1) or request for at least one PUCCH repetitions for Msg4 HARQ-ACK or a request of a number of PUCCH repetitions for Msg4 HARQ-ACK. As illustrated in FIG. 3H, the UL-CCCH1-Message message 300H may further include an RRCResumeRequest1 message. Therefore, in fact, the indication of UE capability or request via UL-CCCH1-Message message 300H can be implemented with the spare bits included in the RRCResumeRequest1 message, since the RRCResumeRequest1 message is included in the UL-CCCH1-Message message 300H.

It is to be noted that the UL-CCCH1-Message message 300H itself includes spare subfields (i.e., “spare3”, “spare2” and “spare1”) in the UL-CCCH1-MessageType field. Therefore, the indication of UE capability or request may be realized by utilizing such spare subfields defined in the UL-CCCH1-MessageType field in the UL-CCCH1-Message message 300H. For example, one or more bits in the spare bits contained in UL-CCCH1-Message message may be used for indicating the information of UE capability or the request.

FIG. 3I illustrates a schematic diagram illustrating an RRCResumeRequest1 message 300I in accordance with some example embodiments of the present disclosure. The RRCResumeRequest1 message 300I may be included in the UL-CCCH1-Message message 300H as illustrated in FIG. 3H. For the purpose of discussion, the RRCResumeRequest1 message 300I will be described with reference to FIGS. 3A, 3B and 3H.

As illustrated in FIG. 3I, in the RRCResumeRequest1 300I, there is a RRCResumeRequest1-IEs field, in which a “spare” subfield is defined as 1-bit long. Under the context of this disclosure, this spare bit can be utilized for the indication for UE capability or the request for PUCCH repetitions for Msg4 HARQ-ACK or a request of a number of PUCCH repetitions for Msg4 HARQ-ACK.

In some example embodiments, the repurposed spare bit(s) indicates a part of the UE capability or request information, while another part of the UE capability or request information is indicated via other means. For example, the another part of the UE capability or request information may be indicated via at least one “R” field in the MAC subheader, as illustrated in FIG. 3B.

In some example embodiments, the use of the spare bit may be limited to operation under NTN. For example, the terminal device 120 may be allowed to set the spare bit to a value different than “0” if the terminal device 120 supports coverage enhancements and the terminal device 120 is performing UL compensation according to information received through SIB19 (the NTN-specific SIB), i.e. the terminal device 120 is operating in NTN.

With the indication on UE capability or the request, the terminal device (for example, the terminal device 120 as illustrated in FIG. 1) may determine which field of a set of spare fields (within one RRC request) to use for transmission of the UE capability or the request. In one embodiment, the determination is based on a gNB configuration via higher layer signaling. In this case, the network device (for example, the network device 110 as illustrated in FIG. 1) may transmit a configuration on the indication on UE capability or the request to the terminal device via a higher layer signaling, so the terminal device may determine which field of a set of spare fields (within one RRC request) to use for transmission of the UE capability or the request, based on the received configuration on the indication on UE capability or the request. In another embodiment, the determination is based on specification text, in other words, the determination is based on predefinition.

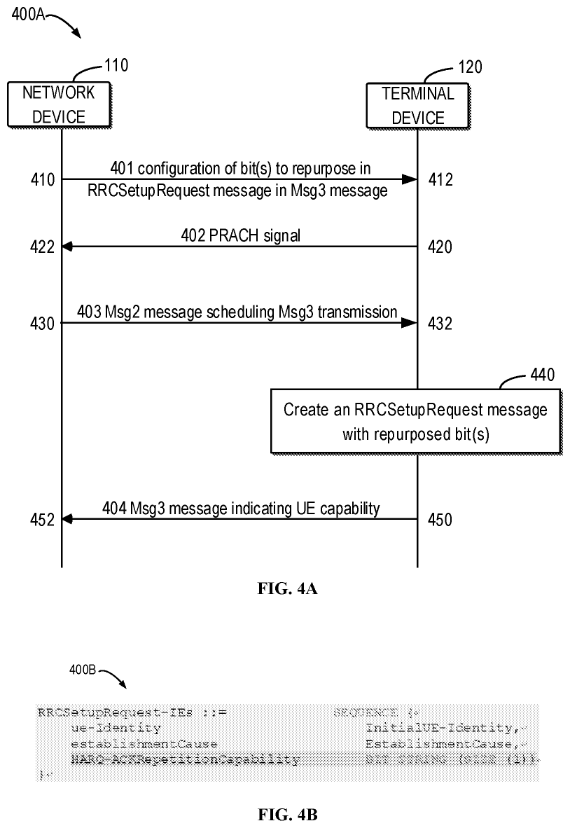

FIG. 4A illustrates a signaling chart illustrating an example communication process 400A in accordance with some example embodiments of the present disclosure. The example communication process 400A illustrates UE capability reporting via repurposing the spare bit in RRCSetupRequest-IEs field in an RRCSetupRequest message. The example communication process 400A may involve a network device (like the network device 110 as illustrated in FIG. 1) and a terminal device (like the terminal device 120 as illustrated in FIG. 1). In the following, the example communication process 400A will be described as executed by the network device 110 and the terminal device 120 as illustrated in FIG. 1. For the purpose of discussion, the example communication process 400A will be described with reference to FIGS. 1-3I.

The network device 110 transmits (410), to the terminal device 120, a configuration 401 of bit(s) to repurpose in RRCSetupRequest message in Msg3, for example via SIB. On the other side of communication, the terminal device 120 receives (412) the configuration 401 from the network device 110. The configuration 401 is used to repurpose at least one spare bit in the RRCSetupRequest message during creating the Msg3 message to indicate UE capability. It is to be noted that, when the configuration 401 is predefined (for example, fixed in the relevant 3GPP specification(s)), this step may be omitted.

In addition, the network device 110 may transmit a configuration of a table mapping the repurposed bit value to the capability meaning (i.e. whether UE supports the capability or not). This is not shown in FIG. 4A. This transmission can be also performed at 410 via a single signaling or in two separate signalings. This transmission may also be performed separately at a different time from 410. On the other side of communication, the terminal device 120 may receive the configuration of the table mapping.

As illustrated in FIG. 4B, the “HARQ-ACKRepetitionCapability” field is defined by reusing the spare bit in the RRCSetupRequest-IEs field. This will be described in more detail later with reference to FIG. 4B.

For example, table mapping of the capability bit value (HARQ-ACKRepetitionCapability) to the meaning may be defined in Table 1:

TABLE 1

| HARQ- | |
|---|---|
| ACKRepetitionCapability | Capability |
| 0 | Not capable of HARQ-ACK repetitions |
| 1 | Capable of HARQ-ACK repetitions |

Here, it is assumed that value “1” is configured in the mapping table. That is, it is indicated that the terminal device 120 is capable of HARQ-ACK repetitions.

In some example embodiments, the spare bit in the RRCSetupRequest message (used by the UE to request the establishment of an RRC connection) is repurposed, as shown in FIG. 4B. As described above with reference to FIG. 3D, the RRCSetupRequest-IEs is the field of the RRCSetupRequest message carried in the Msg3 message.

In some example embodiments, the specific bit(s) to repurpose in the Msg3 message and the table may be defined in the specification, in other words, may be predefined. In this case, the terminal device 120 may determine the repurposed newly defined “HARQ-ACKRepetitionCapability” subfield in the RRCSetupRequest-IEs field in the RRCSetupRequest message, so the network device 110 does not need to transmit the above Table 1 to the terminal device 120.

The terminal device 120 transmits (420) a PRACH signal 402, which is a signal for initiating the random access channel (RACH) procedure, to the network device 110. On the other side of communication, the network device 110 receives (422) the PRACH signal 402, and transmits (430) a Msg2 message 403 to the terminal device 120 for scheduling the subsequent Msg3 message for transmission of the RRCSetupRequest message. On the other side of communication, the terminal device 120 receives (432) the Msg2 message 403.

Then, at block 440, the terminal device 120 creates RRCSetupRequest message with the repurposed bit. In other words, during creating the RRCSetupRequest message to be included in the Msg3 message, based on the value “1” configured in the mapping table indicating that the terminal device 120 is capable of HARQ-ACK repetitions, the terminal device 120 sets the “HARQ-ACKRepetitionCapability” subfield in the RRCSetupRequest-IEs field 400B in the RRCSetupRequest message to be included in a Msg3 message (Msg3 message 404) to value “1” to indicate capability of PUCCH repetitions for Msg4 HARQ-ACK.

The terminal device 120 then transmits (450) the Msg3 message 404 indicating UE capability of the terminal device 120 to the network device 110. The Msg3 message 404 includes the RRCSetupRequest message created at block 440 with indication of the UE capability. On the other side of communication, the network device receives (452) the Msg3 message 404.

FIG. 4B illustrates a schematic diagram illustrating an RRCSetupRequest-IEs field 400B with a spare bit being repurposed in accordance with some example embodiments of the present disclosure. The RRCSetupRequest-IEs field 400B may be included in an RRCSetupRequest message as illustrated in FIG. 3D in the UL-CCCH-Message message 300C as illustrated in FIG. 3C. For the purpose of discussion, the RRCSetupRequest-IEs field 400B will be described with reference to FIGS. 3C, 3D and 4A.

As illustrated in FIG. 4B, in the RRCSetupRequest-IEs field 400B, the original “spare” subfield as shown in FIG. 3D is newly defined as a “HARQ-ACKRepetitionCapability” field for indicating UE capability for PUCCH repetitions for Msg4 HARQ-ACK.

RRCSetupRequest-IEs field 400B is shown here for illustrative purpose. Alternatively, any spare bit or spare state of any type of RRC message(s), including but not limited to the RRCSetupRequest-IEs field 400B in the RRCSetupRequest message as mentioned above, may be utilized solely or in combination to indicate UE capability for PUCCH repetitions for Msg4 HARQ-ACK. For example, a spare bit of an RRC message may be used to indicate the re-interpretation of another spare bit or spare state in the RRC message or accompanying MAC subheader corresponding to the Msg3 message including the RRC message. More specifically, in one example, the spare bit of the RRCSetupRequest-IEs field as illustrated in FIG. 3D may be used to indicate the re-interpretation of one spare bit in a spare state (for example, “spare6” among the six spare states “spare6”, “spare5”, “spare4”, “spare3”, “spare2” and “spare1”) as illustrated in FIG. 3D to be repurposed to indicate the UE capability for PUCCH repetitions for Msg4 HARQ-ACK. In this case, the spare bit of the RRCSetupRequest-IEs field is used for re-interpretation of one spare bit in a spare state “spare6”, and the value of the re-interpreted one spare bit in the spare state “spare6” indicates the UE capability for PUCCH repetitions for Msg4 HARQ-ACK. In another example, the spare bit of the RRCSetupRequest-IEs field may be used to indicate the re-interpretation of at least one of the “R” reserved bits as illustrated in FIG. 3B in the accompanying MAC subheader corresponding to the Msg3 message including the RRCSetupRequest message. In this case, the value of the re-interpreted at least one “R” bit indicates the UE capability for PUCCH repetitions for Msg4 HARQ-ACK.

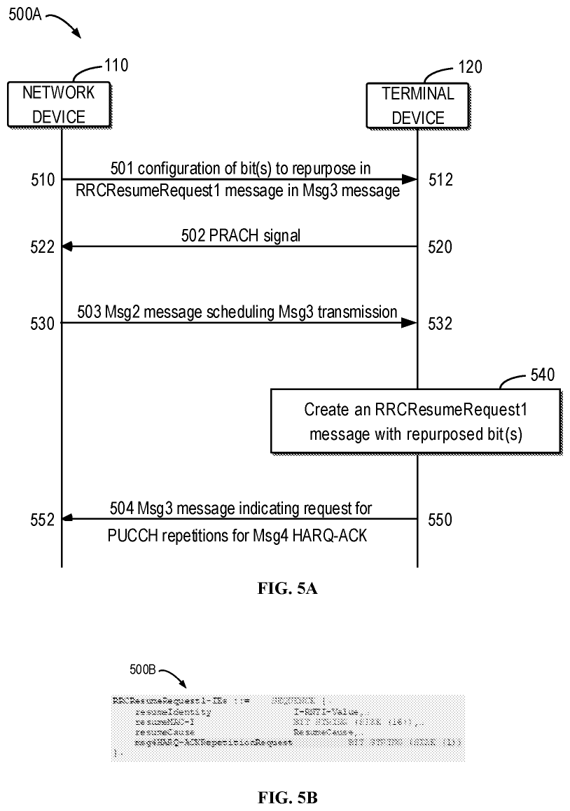

FIG. 5A illustrates a signaling chart illustrating another example communication process 500A in accordance with some example embodiments of the present disclosure. The example communication process 500A illustrates reporting a request for PUCCH repetitions for Msg4 HARQ-ACK via repurposing the spare bit in RRCResumeRequest1-IEs field in an RRCResumeRequest1 message. The example communication process 500A may involve a network device (like the network device 110 as illustrated in FIG. 1) and a terminal device (like the terminal device 120 as illustrated in FIG. 1). In the following, the example communication process 500A will be described as executed by the network device 110 and the terminal device 120 as illustrated in FIG. 1. For the purpose of discussion, the example communication process 500A will be described with reference to FIGS. 1-4A.

The network device 110 transmits (510), to the terminal device 120, a configuration 501 of bit(s) to repurpose in RRCResumeRequest1 message in Msg3, for example via SIB. On the other side of communication, the terminal device 120 receives (512) the configuration 501 from the network device 110. The configuration 501 is used to repurpose at least one spare bit in the RRCResumeRequest1 message during creating the Msg3 message to indicate a request for PUCCH repetitions for Msg4 HARQ-ACK. It is to be noted that, when the configuration 501 is predefined (for example, fixed in the relevant 3GPP specification(s)), this step may be omitted.

In addition, the network device 110 may transmit a configuration of a table mapping the repurposed bit value to the request meaning (i.e. whether terminal device 120 request for PUCCH repetitions for Msg4 HARQ-ACK or not). This is not shown in FIG. 5A. This transmission can be also performed at 510 via a single signaling or in two separate signalings. This transmission may also be performed separately at a different time from 510. On the other side of communication, the terminal device 120 may receive the configuration of the table mapping.

As illustrated in FIG. 5B, the “msg4HARQ-ACKRepetitionRequest” field is defined by reusing the spare bit in the RRCResumeRequest1-IEs field. This will be described in more detail later with reference to FIG. 5B.

For example, table mapping of the request bit value (msg4HARQ-ACKRepetitionRequest) to the meaning may be defined in Table 2:

TABLE 2

| msg4HARQ-ACKRepetitionRequest | Request |
|---|---|
| 0 | Do not request PUCCH repetitions |
| | for Msg4 HARQ-ACK |
| 1 | Request PUCCH repetitions for |
| | Msg4 HARQ-ACK |

Here, it is assumed that value “1” is configured in the mapping table. That is, it is indicated that the terminal device 120 request PUCCH repetitions for Msg4 HARQ-ACK.

In some example embodiments, the spare bit in the RRCResumeRequest1-IEs field in the RRCResumeRequest1 message (used by the UE to resume the establishment of an RRC connection) is repurposed, as shown in FIG. 5B. As described above with reference to FIG. 3I, the RRCResumeRequest1-IEs is a field of the RRCResumeRequest1 message carried in the Msg3 message.

In some example embodiments, the specific bit(s) to repurpose in the Msg3 message and the table may be defined in the specification, in other words, may be predefined. In this case, the terminal device 120 may determine the repurposed newly defined “msg4HARQ-ACKRepetitionRequest” subfield in the RRCResumeRequest1-IEs field in the RRCResumeRequest1 message, so the network device 110 does not need to transmit the above Table 2 to the terminal device 120.

The terminal device 120 transmits (520) a PRACH signal 502, which is a signal for initiating the random access channel (RACH) procedure, to the network device 110. The PRACH signal 502 is similar to the PRACH signal 402 as illustrated in FIG. 4A, so detailed description on FIG. 4A may be referred to and thus omitted here for simplicity.

On the other side of communication, the network device 110 receives (522) the PRACH signal 502, and transmits (530) a Msg2 message 503 to the terminal device 120 for scheduling the subsequent Msg3 message for transmission of the RRCResumeRequest1 message. On the other side of communication, the terminal device 120 receives (532) the Msg2 message 503.

Then, at block 540, the terminal device 120 creates RRCResumeRequest1 message with the repurposed bit. In other words, during creating the RRCResumeRequest1 message to be included in the Msg3 message, based on the value “1” configured in the mapping table (i.e., the above Table 2) indicating that the terminal device 120 requests PUCCH repetitions for Msg4 HARQ-ACK, the terminal device 120 sets the “msg4HARQ-ACKRepetitonRequest” subfield in the RRCResumeRequest1-IEs field 500B in the RRCResumeRequest1 message to be included in a Msg3 message (Msg3 message 504) to value “1” to indicate that the terminal device 120 requests PUCCH repetitions for Msg4 HARQ-ACK.

The terminal device 120 then transmits (550) the Msg3 message 504 indicating that the terminal device 120 requests PUCCH repetitions for Msg4 HARQ-ACK to the network device 110. The Msg3 message 504 includes the RRCResumeRequest1 message created at block 540 with indication of that the terminal device 120 requests PUCCH repetitions for Msg4 HARQ-ACK. On the other side of communication, the network device receives (552) the Msg3 message 504.

FIG. 5B illustrates a schematic diagram illustrating an RRCResumeRequest1-IEs field 500B with a spare bit being repurposed in accordance with some example embodiments of the present disclosure. The RRCResumeRequest1-IEs field 500B may be included in an RRCResumeRequest1 message as illustrated in FIG. 3I in the UL-CCCH1-Message message 300H as illustrated in FIG. 3H. For the purpose of discussion, the RRCResumeRequest1-IEs field 500B will be described with reference to FIGS. 3H, 3I and 5A.

As illustrated in FIG. 5B, in the RRCResumeRequest1-IEs field 500B, the original “spare” subfield as shown in FIG. 3I is newly defined as a “msg4HARQ-ACKRepetitonRequest” subfield for the indication that the terminal device 120 requests PUCCH repetitions for Msg4 HARQ-ACK.

RRCResumeRequest1-IEs field 500B is shown here for illustrative purpose. Alternatively, any spare bit or spare state of any type of RRC message(s), including but not limited to the RRCResumeRequest1-IEs field 500B in the RRCResumeRequest1 message as mentioned above, may be utilized solely or in combination for the indication that the terminal device 120 requests PUCCH repetitions for Msg4 HARQ-ACK. For example, spare bits in the RRCSetupRequest-IEs field or spare states in EstablishmentCause field in RRCSetupRequest message can also be used to be repurposed to request PUCCH repetitions for Msg4 HARQ-ACK. Alternatively, a spare bit of an RRC message may be used to indicate the re-interpretation of another spare bit or spare state in the RRC message or accompanying MAC subheader corresponding to the Msg3 message including the RRC message. More specifically, in one example, the spare bit of the RRCSetupRequest-IEs field as illustrated in FIG. 3D may be used to indicate the re-interpretation of one spare bit in a spare state (for example, “spare3” among the six spare states “spare6”, “spare5”, “spare4”, “spare3”, “spare2” and “spare1”) as illustrated in FIG. 3D to be repurposed to indicate that the terminal device 120 requests for PUCCH repetitions for Msg4 HARQ-ACK. In this case, the spare bit of the RRCSetupRequest-IEs field is used for re-interpretation of one spare bit in a spare state “spare3”, and the value of the re-interpreted one spare bit in the spare state “spare3” indicates whether the terminal device 120 requests for PUCCH repetitions for Msg4 HARQ-ACK or not. In another example, the spare bit of the RRCSetupRequest-IEs field may be used to indicate the re-interpretation of at least one of the “R” reserved bits as illustrated in FIG. 3B in the accompanying MAC subheader corresponding to the Msg3 message including the RRCSetupRequest message. In this case, the value of the re-interpreted at least one “R” bit indicates whether the terminal device 120 requests for PUCCH repetitions for Msg4 HARQ-ACK or not.

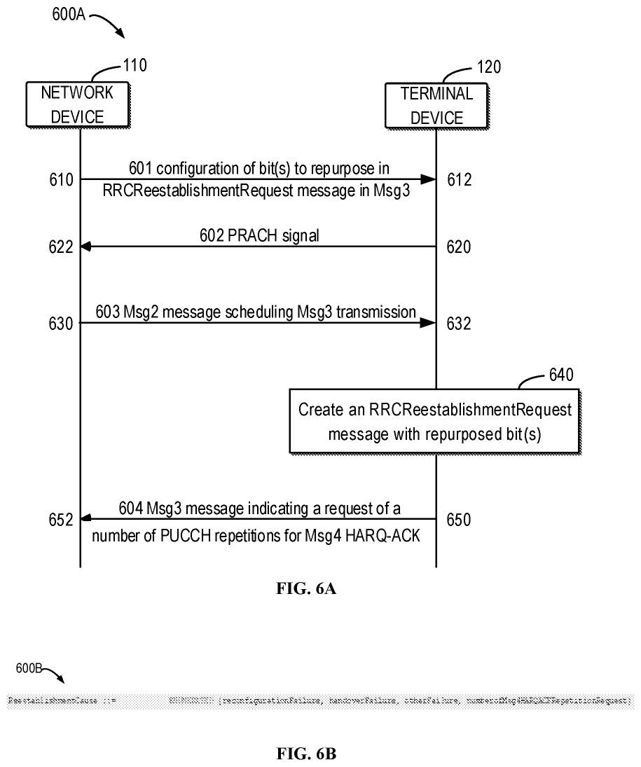

FIG. 6A illustrates a signaling chart illustrating another example communication process 600A in accordance with some example embodiments of the present disclosure. The example communication process 600A illustrates reporting a request of a number of PUCCH repetitions (or also referred to as PUCCH repetition factor in this application) for Msg4 HARQ-ACK via repurposing a spare state in RRCReestablishmentRequest-IEs field in an RRCReestablishmentRequest message. The example communication process 600A may involve a network device (like the network device 110 as illustrated in FIG. 1) and a terminal device (like the terminal device 120 as illustrated in FIG. 1). In the following, the example communication process 600A will be described as executed by the network device 110 and the terminal device 120 as illustrated in FIG. 1. For the purpose of discussion, the example communication process 600A will be described with reference to FIGS. 1-4A.

The network device 110 transmits (610), to the terminal device 120, a configuration 601 of bit(s) to repurpose in RRCReestablishmentRequest message in Msg3. On the other side of communication, the terminal device 120 receives (612) the configuration 601 from the network device 110. The configuration 601 is used to repurpose at least one spare bit in the RRCReestablishmentRequest message during creating the Msg3 message to indicate a request of a number of PUCCH repetitions for Msg4 HARQ-ACK. It is to be noted that, when the configuration 601 is predefined (for example, fixed in the relevant 3GPP specification(s)), this step may be omitted.

In addition, the network device 110 may transmit a configuration of a table mapping the repurposed bit value to the request meaning (i.e. the number of PUCCH repetitions for Msg4 HARQ-ACK). This is not shown in FIG. 6A. This transmission can be also performed at 610 via a single signaling or in two separate signalings. This transmission may also be performed separately at a different time from 610. On the other side of communication, the terminal device 120 may receive the configuration of the table mapping.

As illustrated in FIG. 6B, the “numberofMsg4HARQACKRepetitionsRequest” subfield is defined by reusing a spare state in the RRCReestablishmentRequest-IEs field in an RRCReestablishmentRequest message as illustrated in FIG. 3F to be included in a UL-CCCH-Message message as illustrated in FIG. 3C in a Msg3 message (Msg3 message 604). This will be described in more detail later with reference to FIG. 6B.

For example, table mapping of the request bit value (numberofMsg4HARQACKRepetitionsRequest) to the meaning may be defined in Table 3:

TABLE 3

| | the number of PUCCH |
|---|---|
| | Repetitions for Msg4 |
| numberofMsg4HARQACKRepetitionsRequest | HARQ-ACK |
| 00 | No PUCCH repetition for |
| | Msg4 HARQ-ACK |
| 01 | 2 PUCCH repetitions for |
| | Msg4 HARQ-ACK |
| 10 | 4 PUCCH repetitions for |
| | Msg4 HARQ-ACK |
| 11 | 8 PUCCH repetitions for |
| | Msg4 HARQ-ACK |

Here, it is assumed that value “10” is selected by the terminal device 120 from the mapping table (i.e., the above Table 3) configured by the network device 110 (the Table 3 may also be predefined, in which case the terminal device 120 can select a value from the Table 3 at local without receiving it from the network device 110). That is, it is indicated that the terminal device 120 request 4 PUCCH repetitions for Msg4 HARQ-ACK; in other words, for a Msg4 HARQ-ACK message, 4 PUCCH repetitions are requested by the terminal device 120, for example, in order to improve communication performance.

In some example embodiments, the spare state in the RRCReestablishmentRequest-IEs field in the RRCReestablishmentRequest message (used by the UE to reestablish an RRC connection) is repurposed, as shown in FIG. 6B. As described above with reference to FIG. 3F, the RRCReestablishmentRequest-IEs is a field of the RRCReestablishmentRequest message to be included in a UL-CCCH-Message message as illustrated in FIG. 3C which is in turn to be included in the Msg3 message (Msg3 message 604).

In some example embodiments, the specific bit(s) to repurpose in the Msg3 message and the mapping table (i.e., the above Table 3) may be defined in the specification, in other words, may be predefined. In this case, the terminal device 120 may determine the repurposed newly defined “numberofMsg4HARQACKRepetitionsRequest” subfield in the RRCReestablishmentRequest-IEs field in the RRCReestablishmentRequest message, so the network device 110 does not need to transmit the above Table 3 to the terminal device 120.

The terminal device 120 transmits (620) a PRACH signal 602, which is a signal for initiating the random access channel (RACH) procedure, to the network device 110. The PRACH signal 602 is similar to the PRACH signal 402 as illustrated in FIG. 4A, so detailed description on FIG. 4A may be referred to and thus omitted here for simplicity.

On the other side of communication, the network device 110 receives (622) the PRACH signal 602, and transmits (630) a Msg2 message 603 to the terminal device 120 for scheduling the subsequent Msg3 message for transmission f the RRCReestablishmentRequest message. On the other side of communication, the terminal device 120 receives (632) the Msg2 message 603.

Then, at block 640, the terminal device 120 creates RRCReestablishmentRequest message with the repurposed bit. In other words, during creating the RRCReestablishmentRequest message to be included in the Msg3 message, based on the value “4” selected by the terminal device 120 from the mapping table (i.e., the above Table 3) indicating that the terminal device 120 requests 4 PUCCH repetitions for Msg4 HARQ-ACK, the terminal device 120 sets the “numberofMsg4HARQACKRepetitionsRequest” subfield in the RRCReestablishmentRequest-IEs field 600B in the RRCReestablishmentRequest message to be included in a Msg3 message (Msg3 message 604) to value “01” to indicate that the terminal device 120 requests 4 PUCCH repetitions for Msg4 HARQ-ACK.

The terminal device 120 then transmits (650) the Msg3 message 604 indicating that the terminal device 120 requests 4 PUCCH repetitions for Msg4 HARQ-ACK to the network device 110. The Msg3 message 604 includes the RRCReestablishmentRequest message created at block 640 with indication of that the terminal device 120 requests 4 PUCCH repetitions for Msg4 HARQ-ACK. On the other side of communication, the network device receives (652) the Msg3 message 604.

FIG. 6B illustrates a schematic diagram illustrating an RRCReestablishmentRequest-IEs field 600B with a spare state being repurposed in accordance with some example embodiments of the present disclosure. The RRCReestablishmentRequest-IEs field 600B included in may be an RRCReestablishmentRequest message as illustrated in FIG. 3F in the UL-CCCH-Message message 300C as illustrated in FIG. 3C. For the purpose of discussion, the RRCReestablishmentRequest-IEs field 600B will be described with reference to FIGS. 3C, 3F and 6A.

As illustrated in FIG. 6B, in the RRCReestablishmentRequest-IEs field 600B, the original spare state “spare1” subfield as shown in FIG. 3F is newly defined as a “numberofMsg4HARQACKRepetitionsRequest” subfield for the indication that the terminal device 120 requests 4 PUCCH repetitions for Msg4 HARQ-ACK.

For example, the number of PUCCH Repetitions for Msg4 HARQ-ACK may be chosen from {1, 2, 4, 8}, each of the values “1”, “2”, “4” and “8” may be represented by 2-bit of the spare state “spare1” which is a subfield of the ReestablishmentCause field in the RRCReestablishmentRequest-IEs field 600B. For example, each of the values “1”, “2”, “4” and “8” may be represented by a 2-bit sequence as “00”, “01”, “10” and “11”, respectively.

RRCReestablishmentRequest-IEs field 600B is shown here for illustrative purpose. Alternatively, any spare bit or spare state of any type of RRC message(s), including but not limited to the RRCReestablishmentRequest-IEs field 600B in the RRCReestablishmentRequest message as mentioned above, may be utilized solely or in combination for indicating a requests of the number of PUCCH repetitions for Msg4 HARQ-ACK. For example, spare sates in EstablishmentCause field in RRCSetupRequest message can also be used to be repurposed to indicate the number of PUCCH repetitions for Msg4 HARQ-ACK. Alternatively, spare bit of several fields may be combined to be repurposed to indicate the number of PUCCH repetitions for Msg4 HARQ-ACK. For example, the one spare bit in RRCSetupRequest-IEs field in the RRCSetupRequest message and one spare state among the spare states “spare6”, “spare5”, “spare4”, “spare3”, “spare2” and “spare1” in the EstablishmentCause field in the RRCSetupRequest message may be combined to be repurposed to indicate the number of PUCCH repetitions for Msg4 HARQ-ACK. More specifically, for example, the one spare bit in RRCSetupRequest-IEs field and one bit of one spare state (for example, “spare6”) may be combined to be repurposed to indicate the number of PUCCH repetitions for Msg4 HARQ-ACK, in the same manner as described with reference to FIGS. 6A and 6B. Alternatively, a spare bit of an RRC message may be used to indicate the re-interpretation of the “R” reserved bits in the accompanying MAC subheader corresponding to the Msg3 message including the RRC message. For example, the spare bit of an RRCSystemInfoRequest-IEs field in an RRCSystemInfoRequest message may be used to indicate the re-interpretation of the two “R” reserved bits as illustrated in FIG. 3B in the accompanying MAC subheader corresponding to the Msg3 message including the RRCSystemInfoRequest message.

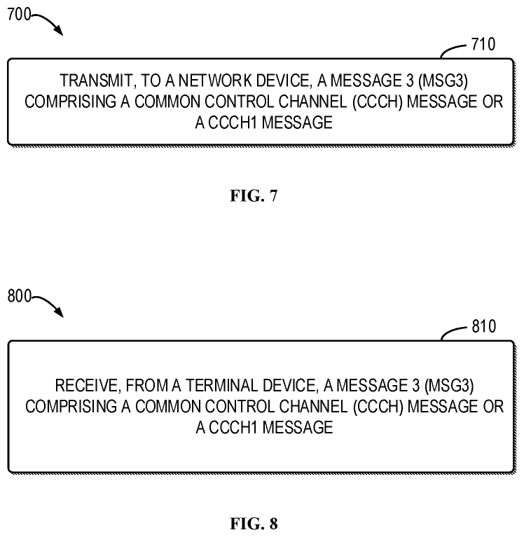

FIG. 7 illustrates a flowchart of an example method 700 implemented at a terminal device 120 in accordance with some other embodiments of the present disclosure. For the purpose of discussion, the method 700 will be described from the perspective of the terminal device 120 with reference to FIGS. 1, 2 and 4A-6B.

At block 710, the terminal device 120 transmits, to the network device 110, a Msg3 message comprising a CCCH message (for example, either a UL-CCCH-Message message or a UL-CCCH1-Message message). Here, at least one spare bit in a RRC message in the CCCH message is used for indicating information related to PUCCH repetitions for Msg4 HARQ-ACK. In one example, as illustrated in FIG. 2, the terminal device 120 transmits (210) a Msg3 message 201 comprising a CCCH message to the network device 110. In another example, as illustrated in FIG. 4A, the terminal device 120 transmits (450) a Msg3 message 404 indicating UE capability to the network device 110. In yet another example, as illustrated in FIG. 5A, the terminal device 120 transmits (550) a Msg3 message 504 indicating a request for PUCCH repetitions for Msg4 HARQ-ACK to the network device 110. In still another example, as illustrated in FIG. 6A, the terminal device 120 transmits (650) a Msg3 message 604 indicating a request of a number of PUCCH repetitions for Msg4 HARQ-ACK to the network device 110.

In some example embodiments, the CCCH message may comprise a UL-CCCH-Message message. Alternatively, the CCCH message may comprise a UL-CCCH1-Message message. In some example embodiments, the information related to PUCCH repetitions for Msg4 HARQ-ACK may comprise a capability of the terminal device for PUCCH repetitions for Msg4 HARQ-ACK. Alternatively or additionally, the information may comprise a request for PUCCH repetitions for Msg4 HARQ-ACK. Alternatively or additionally, the information may comprise a request of a number of PUCCH repetitions for Msg4 HARQ-ACK.

In some example embodiments, the information may comprise an indication of re-interpretation of at least one bit in the RRC message to be the at least one spare bit. In some example embodiments, the RRC message may be an RRCSetupRequest message, and the at least one bit may comprise at least one spare enumerated value of an EstablishmentCause field in the RRCSetupRequest message.

In some example embodiments, the RRC message may be an RRCReestablishmentRequest message, and the at least one bit may comprise at least one spare enumerated value of a ReestablishmentCause field in the RRCReestablishmentRequest message. In some example embodiments, a part of the information may be indicated by the at least one spare bit in the RRC message. In some example embodiments, another part of the information may be indicated by at least one “R” (reserved) bit in a medium access control (MAC) subheader in the Msg3 message 201.

In some example embodiments, before the terminal device 120 transmits (210) the Msg3 message 201, the terminal device 120 may further obtain a configuration of the at least one spare bit in the RRC message to indicate the information, and set the at least one spare bit in the RRC message based on the configuration of the at least one spare bit and the information.

In some example embodiments, in order to obtain the configuration, the terminal device 120 may receive the configuration from the network device 110 via higher layer signaling. Alternatively, in order to obtain the configuration, the terminal device 120 may determine the configuration which is preconfigured at the terminal device 120.

In some example embodiments, the RRC message may comprise an RRCResumeRequest message. Alternatively or additionally, the RRC message may comprise an RRCResumeRequest1 message. Alternatively or additionally, the RRC message may comprise an RRCSystemInfoRequest message.

In some example embodiments, a single spare bit in an RRCSetupRequest-IEs field in an RRCSetupRequest message may be used for indicating the information. Alternatively or additionally, at least one spare state of an EstablishmentCause field in an RRCSetupRequest message may be used for indicating the information. Alternatively or additionally, a single spare bit in an RRCResumeRequest-IEs field in an RRCResumeRequest message may be used for indicating the information. Alternatively or additionally, a single spare bit in an RRCResumeRequest1-IEs field in an RRCResumeRequest1 message may be used for indicating the information.

Alternatively or additionally, a single spare bit in an RRCReestablishmentRequest-IEs field in an RRCReestablishmentRequest message may be used for indicating the information. Alternatively or additionally, at least one spare state of a ReestablishmentCause field in an RRCReestablishmentRequest message may be used for indicating the information. Alternatively or additionally, at least one spare bit in an RRCSystemInfoRequest-IEs field in an RRCSystemInfoRequest message may be used for indicating the information. Alternatively or additionally, at least one spare type in an UL-CCCH-MessageType field in an UL-CCCH1-Message message may be used for indicating the information. In some example embodiments, the at least one spare bit may be used for indicating the information when the terminal device 120 is in an NTN.

FIG. 8 illustrates another flowchart of an example method 800 implemented at a network device in accordance with some other embodiments of the present disclosure. For the purpose of discussion, the method 800 will be described from the perspective of the network device 110 with reference to FIGS. 1, 2 and 4A-6B.

At block 810, the network device 110 receives, from the terminal device 120, a Msg3 message comprising a CCCH message. Here, at least one spare bit in a RRC message in the CCCH message is used for indicating information related to PUCCH repetitions for Msg4HARQ-ACK. In one example, as illustrated in FIG. 2, the network device 110 receives (212) a Msg3 message 201 comprising a CCCH message from the terminal device 120. In another example, as illustrated in FIG. 4A, the network device 110 receives (452) a Msg3 message 404 indicating UE capability from the terminal device 120. In yet another example, as illustrated in FIG. 5A, the network device 110 receives (552) a Msg3 message 504 indicating a request for PUCCH repetitions for Msg4 HARQ-ACK from the terminal device 120. In still another example, as illustrated in FIG. 6A, the network device 110 receives (652) a Msg3 message 604 indicating a request of a number of PUCCH repetitions for Msg4 HARQ-ACK from the terminal device 120.

In some example embodiments, the CCCH message may comprise a UL-CCCH-Message message. Alternatively, the CCCH message may comprise a UL-CCCH1-Message message. In some example embodiments, the information related to PUCCH repetitions for Msg4 HARQ-ACK may comprise a capability of the terminal device for PUCCH repetitions for Msg4 HARQ-ACK. Alternatively or additionally, the information may comprise a request for PUCCH repetitions for Msg4 HARQ-ACK. Alternatively or additionally, the information may comprise a request of a number of PUCCH repetitions for Msg4 HARQ-ACK.

In some example embodiments, the information may comprise an indication of re-interpretation of at least one bit in the RRC message to be the at least one spare bit.

In some example embodiments, the RRC message may be an RRCSetupRequest message, and the at least one bit may comprise at least one spare enumerated value of an EstablishmentCause field in the RRCSetupRequest message.

In some example embodiments, the RRC message may be an RRCReestablishmentRequest message, and the at least one bit may comprise at least one spare enumerated value of a ReestablishmentCause field in the RRCReestablishmentRequest message. In some example embodiments, a part of the information may be indicated by the at least one spare bit in the RRC message.

In some example embodiments, another part of the information may be indicated by at least one “R” (reserved) bit in a medium access control (MAC) subheader in the Msg3 message 201. In some example embodiments, before receiving the Msg3 message 201, the network device 110 may determine a configuration of the at least one spare bit in the RRC message to indicate the information, and transmit the configuration to the terminal device 120.

In some example embodiments, the RRC message may comprise an RRCResumeRequest message. Alternatively or additionally, the RRC message may comprise an RRCResumeRequest1 message. Alternatively or additionally, the RRC message may comprise an RRCSystemInfoRequest message.

In some example embodiments, a single spare bit in an RRCSetupRequest-IEs field in an RRCSetupRequest message may be used for indicating the information. Alternatively or additionally, at least one spare state of an EstablishmentCause field in an RRCSetupRequest message may be used for indicating the information. Alternatively or additionally, a single spare bit in an RRCResumeRequest-IEs field in an RRCResumeRequest message may be used for indicating the information. Alternatively or additionally, a single spare bit in an RRCResumeRequest1-IEs field in an RRCResumeRequest1 message may be used for indicating the information.

Alternatively or additionally, a single spare bit in an RRCReestablishmentRequest-IEs field in an RRCReestablishmentRequest message may be used for indicating the information. Alternatively or additionally, at least one spare state of a ReestablishmentCause field in an RRCReestablishmentRequest message may be used for indicating the information. Alternatively or additionally, at least one spare bit in an RRCSystemInfoRequest-IEs field in an RRCSystemInfoRequest message may be used for indicating the information. Alternatively or additionally, at least one spare type in an UL-CCCH-MessageType field in an UL-CCCH1-Message message may be used for indicating the information. In some example embodiments, the at least one spare bit may be used for indicating the information when the terminal device 120 is in an NTN.

In some embodiments, an apparatus capable of performing the method 700 (for example, the terminal device 120) may comprise means for performing the respective steps of the method 700. The means may be implemented in any suitable form. For example, the means may be implemented in a circuitry or software module.

In some example embodiments, the apparatus comprises: means for transmitting a Msg3 message (for example, the Msg3 message 201 as illustrated in FIG. 2, or the Msg3 message 404 as illustrated in FIG. 4A, or the Msg3 message 504 as illustrated in FIG. 5A, or the Msg3 message 604 as illustrated in FIG. 6A) comprising a CCCH message. At least one spare bit in a radio resource control (RRC) message in the CCCH message is used for indicating information related to physical uplink control channel (PUCCH) repetitions for Message 4 (Msg4) hybrid automatic repeat request-acknowledgement (HARQ-ACK).

In some example embodiments, the CCCH message may comprise a UL-CCCH-Message message. Alternatively, the CCCH message may comprise a UL-CCCH1-Message message. In some example embodiments, the information related to PUCCH repetitions for Msg4 HARQ-ACK may comprise a capability of the terminal device for PUCCH repetitions for Msg4 HARQ-ACK. Alternatively or additionally, the information may comprise a request for PUCCH repetitions for Msg4 HARQ-ACK. Alternatively or additionally, the information may comprise a request of a number of PUCCH repetitions for Msg4 HARQ-ACK.

In some example embodiments, the information may comprise an indication of re-interpretation of at least one bit in the RRC message to be the at least one spare bit. In some example embodiments, the RRC message may be an RRCSetupRequest message, and the at least one bit may comprise at least one spare enumerated value of an EstablishmentCause field in the RRCSetupRequest message.

In some example embodiments, the RRC message may be an RRCReestablishmentRequest message, and the at least one bit may comprise at least one spare enumerated value of a ReestablishmentCause field in the RRCReestablishmentRequest message.

In some example embodiments, a part of the information may be indicated by the at least one spare bit in the RRC message. In some example embodiments, another part of the information may be indicated by at least one “R” (reserved) bit in a medium access control (MAC) subheader in the Msg3 message 201.

In some example embodiments, the apparatus may further comprise means for, prior to transmitting the Msg3 message 201, obtaining a configuration of the at least one spare bit in the RRC message to indicate the information. Additionally, the may further comprise means for setting the at least one spare bit in the RRC message based on the configuration of the at least one spare bit and the information.

In some example embodiments, the means for obtaining may comprise means for receiving the configuration from the network device 110 via higher layer signaling. Alternatively or additionally, the means for obtaining may comprise means for determining the configuration which is preconfigured.

In some example embodiments, the RRC message may comprise an RRCResumeRequest message. Alternatively or additionally, the RRC message may comprise an RRCResumeRequest1 message. Alternatively or additionally, the RRC message may comprise an RRCSystemInfoRequest message.

In some example embodiments, a single spare bit in an RRCSetupRequest-IEs field in an RRCSetupRequest message may be used for indicating the information. Alternatively or additionally, at least one spare state of an EstablishmentCause field in an RRCSetupRequest message may be used for indicating the information. Alternatively or additionally, a single spare bit in an RRCResumeRequest-IEs field in an RRCResumeRequest message may be used for indicating the information. Alternatively or additionally, a single spare bit in an RRCResumeRequest1-IEs field in an RRCResumeRequest1 message may be used for indicating the information.

Alternatively or additionally, a single spare bit in an RRCReestablishmentRequest-IEs field in an RRCReestablishmentRequest message may be used for indicating the information. Alternatively or additionally, at least one spare state of a ReestablishmentCause field in an RRCReestablishmentRequest message may be used for indicating the information. Alternatively or additionally, at least one spare bit in an RRCSystemInfoRequest-IEs field in an RRCSystemInfoRequest message may be used for indicating the information. Alternatively or additionally, at least one spare type in an UL-CCCH-MessageType field in an UL-CCCH1-Message message may be used for indicating the information. In some example embodiments, the at least one spare bit may be used for indicating the information when the terminal device 120 is in an NTN.

In some embodiments, the apparatus further comprises means for performing other steps in some embodiments of the method 700. In some embodiments, the means comprises at least one processor and at least one memory including computer program code, the at least one memory and computer program code are configured to, with the at least one processor, cause the performance of the apparatus.

In some embodiments, an apparatus capable of performing the method 800 (for example, the network device 110) may comprise means for performing the respective steps of the method 800. The means may be implemented in any suitable form. For example, the means may be implemented in a circuitry or software module.

In some example embodiments, the apparatus comprises: means for receiving a Msg3 message (for example, the Msg3 message 201 as illustrated in FIG. 2, or the Msg3 message 404 as illustrated in FIG. 4A, or the Msg3 message 504 as illustrated in FIG. 5A, or the Msg3 message 604 as illustrated in FIG. 6A) comprising a CCCH message. At least one spare bit in a RRC message in the CCCH message is used for indicating information related to PUCCH repetitions for Msg4 HARQ-ACK.

In some example embodiments, the CCCH message may comprise a UL-CCCH-Message message. Alternatively, the CCCH message may comprise a UL-CCCH1-Message message. In some example embodiments, the information related to PUCCH repetitions for Msg4 HARQ-ACK may comprise a capability of the terminal device for PUCCH repetitions for Msg4 HARQ-ACK. Alternatively or additionally, the information may comprise a request for PUCCH repetitions for Msg4 HARQ-ACK. Alternatively or additionally, the information may comprise a request of a number of PUCCH repetitions for Msg4 HARQ-ACK.

In some example embodiments, the information may comprise an indication of re-interpretation of at least one bit in the RRC message to be the at least one spare bit. In some example embodiments, the RRC message may be an RRCSetupRequest message, and the at least one bit may comprise at least one spare enumerated value of an EstablishmentCause field in the RRCSetupRequest message.

In some example embodiments, the RRC message may be an RRCReestablishmentRequest message, and the at least one bit may comprise at least one spare enumerated value of a ReestablishmentCause field in the RRCReestablishmentRequest message.

In some example embodiments, a part of the information may be indicated by the at least one spare bit in the RRC message. In some example embodiments, another part of the information may be indicated by at least one “R” (reserved) bit in a medium access control (MAC) subheader in the Msg3 message 201.

In some example embodiments, the apparatus may further comprise means for determining a configuration of the at least one spare bit in the RRC message to indicate the information. Additionally, the apparatus may further comprise means for transmitting the configuration to the terminal device 120.

In some example embodiments, the RRC message may comprise an RRCResumeRequest message. Alternatively or additionally, the RRC message may comprise an RRCResumeRequest1 message. Alternatively or additionally, the RRC message may comprise an RRCSystemInfoRequest message.

In some example embodiments, a single spare bit in an RRCSetupRequest-IEs field in an RRCSetupRequest message may be used for indicating the information. Alternatively or additionally, at least one spare state of an EstablishmentCause field in an RRCSetupRequest message may be used for indicating the information. Alternatively or additionally, a single spare bit in an RRCResumeRequest-IEs field in an RRCResumeRequest message may be used for indicating the information. Alternatively or additionally, a single spare bit in an RRCResumeRequest1-IEs field in an RRCResumeRequest1 message may be used for indicating the information.

Alternatively or additionally, a single spare bit in an RRCReestablishmentRequest-IEs field in an RRCReestablishmentRequest message may be used for indicating the information. Alternatively or additionally, at least one spare state of a ReestablishmentCause field in an RRCReestablishmentRequest message may be used for indicating the information. Alternatively or additionally, at least one spare bit in an RRCSystemInfoRequest-IEs field in an RRCSystemInfoRequest message may be used for indicating the information. Alternatively or additionally, at least one spare type in an UL-CCCH-MessageType field in an UL-CCCH1-Message message may be used for indicating the information. In some example embodiments, the at least one spare bit may be used for indicating the information when the terminal device 120 is in an NTN.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

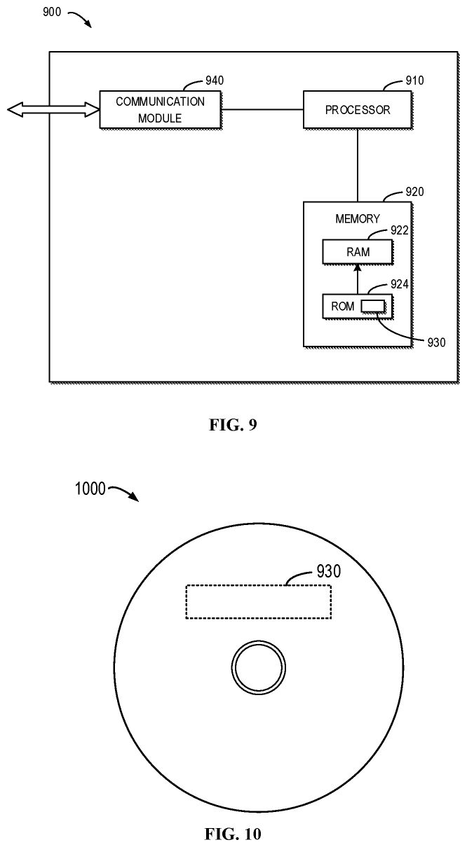

FIG. 9 illustrates a simplified block diagram of a device 900 that is suitable for implementing some example embodiments of the present disclosure. The device 900 may be provided to implement a communication device, for example, the terminal device 120 or the network device 110 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 1130 may be stored in the ROM 924. The processor 910 may perform any suitable actions and processing by loading the program 930 into the RAM 922.

The embodiments of the present disclosure may be implemented by means of the program 930 so that the device 900 may perform any process of the disclosure as discussed with reference to FIGS. 2 and 4-6. The embodiments of the present disclosure may also be implemented by hardware or by a combination of software and hardware.

In some example embodiments, the program 930 may be tangibly contained in a computer-readable medium which may be included in the device 900 (such as in the memory 920) or other storage devices that are accessible by the device 900. The device 900 may load the program 930 from the computer-readable medium to the RAM 922 for execution. The computer-readable medium may include any types of tangible non-volatile storage, such as ROM, EPROM, a flash memory, a hard disk, CD, DVD, and the like.

FIG. 10 illustrates a block diagram of an example of a computer-readable medium 1000 in accordance with some example embodiments of the present disclosure. The computer-readable medium 1000 has the program 930 stored thereon. It is noted that although the computer-readable medium 1000 is depicted in form of CD or DVD in FIG. 10, the computer-readable medium 1000 may be in any other form suitable for carry or hold the program 930.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 700 or 800 as described above with reference to FIG. 7 or 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination. The term “non-transitory,” as used herein, is a limitation of the medium itself (i.e., tangible, not a signal) as opposed to a limitation on data storage persistency (e.g., RAM vs. ROM).

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Through this document, the terms defined below may be referenced.
LEO Low Earth Orbit
LOS Line Of Sight
RACH Random Access Channel
HARQ Hybrid Automatic Repeat Request
ACK Acknowledge
Msg2 Message 2
Msg3 Message3
Msg4 Message4
DCI Downlink Control Information
RAR Random Access Response
SIB System Information Block
TC-RNTI Temporary C-RNTI
PDCCH Physical Downlink Control Channel
PDSCH Physical Downlink Shared Channel
PRACH Physical Random Access Channel
PUCCH Physical Uplink Control Channel
PUSCH Physical Uplink Shared Channel
IE Information Element
RRC Radio Resource Control
LCID Logical Channel ID
MAC Medium Access Control
PDU Protocol Data Unit
SDU Service Data Unit
MAC CE MAC Control Element

1.-30. (canceled)

31. A terminal device comprising:
at least one processor; and
at least one memory storing instructions that, when executed by the at least one processor, cause the terminal device at least to:
operate in a non-terrestrial network (NTN) while performing uplink compensation according to information received in a System Information Block 19 (SIB19);
receive, from a network device via a system information block, a configuration indicating that a one-bit spare subfield of an RRCSetupRequest-IEs field in an RRCSetupRequest message is repurposed as a HARQ-ACKRepetitionCapability field;
transmit, to the network device, a physical random access channel (PRACH) signal;
receive, from the network device, a Message 2 (Msg2) message scheduling transmission of a Message 3 (Msg3) message;
generate the RRCSetupRequest message for requesting establishment of a radio resource control (RRC) connection, wherein the RRCSetupRequest message is included in a UL-CCCH-Message message of the Msg3 message, and wherein the one-bit spare subfield of the RRCSetupRequest-IEs field is set to a value of 1 in accordance with the received configuration to indicate that the terminal device is capable of physical uplink control channel (PUCCH) repetitions for Message 4 (Msg4) hybrid automatic repeat request-acknowledgement (HARQ-ACK); and
transmit, to the network device, the Msg3 message comprising the UL-CCCH-Message message including the RRCSetupRequest message having the HARQ-ACKRepetitionCapability field set to the value of 1.

32. The terminal device of claim 31, wherein the terminal device is a non-reduced capability terminal device, and wherein the CCCH message comprises the UL-CCCH-Message message rather than a UL-CCCH1-Message message.

33. The terminal device of claim 32, wherein the RRCSetupRequest message is a 48-bit RRC message within the UL-CCCH-Message message.

34. The terminal device of claim 33, wherein the UL-CCCH-Message message is included in a common control channel service data unit (CCCH SDU), and wherein the CCCH SDU is included in a medium access control protocol data unit (MAC PDU) with a MAC subheader associated with the CCCH SDU.

35. The terminal device of claim 34, wherein the MAC subheader is placed in front of the CCCH SDU in the MAC PDU.

36. The terminal device of claim 34, wherein the MAC subheader comprises two one-bit reserved fields and a six-bit logical channel identifier (LCID) field.

37. The terminal device of claim 36, wherein the configuration received via the system information block comprises a mapping in which a value of 0 of the HARQ-ACKRepetitionCapability field indicates that the terminal device is not capable of HARQ-ACK repetitions, and the value of 1 of the HARQ-ACKRepetitionCapability field indicates that the terminal device is capable of HARQ-ACK repetitions.

38. The terminal device of claim 37, wherein the PRACH signal initiates a random access channel procedure, and wherein the Msg2 message schedules the Msg3 message for transmission of the RRCSetupRequest message.

39. The terminal device of claim 38, wherein the terminal device sets the one-bit spare subfield to the value of 1 only when the terminal device supports coverage enhancements and is operating in the NTN while performing the uplink compensation according to the information received in SIB19.

40. The terminal device of claim 39, wherein an EstablishmentCause field of the RRCSetupRequest message includes a plurality of spare states, and wherein the one-bit spare subfield of the RRCSetupRequest-IEs field indicates that the EstablishmentCause field is to be re-interpreted for coverage enhancement signaling.

41. A method performed by a terminal device, the method comprising:
operating in a non-terrestrial network (NTN) while performing uplink compensation according to information received in a System Information Block 19 (SIB19);
receiving, from a network device via a system information block, a configuration indicating that a one-bit spare subfield of an RRCSetupRequest-IEs field in an RRCSetupRequest message is repurposed as a HARQ-ACKRepetitionCapability field;
transmitting, to the network device, a physical random access channel (PRACH) signal;
receiving, from the network device, a Message 2 (Msg2) message scheduling transmission of a Message 3 (Msg3) message;
generating the RRCSetupRequest message for requesting establishment of a radio resource control (RRC) connection, wherein the RRCSetupRequest message is included in a UL-CCCH-Message message of the Msg3 message, and wherein the one-bit spare subfield of the RRCSetupRequest-IEs field is set to a value of 1 in accordance with the received configuration to indicate that the terminal device is capable of physical uplink control channel (PUCCH) repetitions for Message 4 (Msg4) hybrid automatic repeat request-acknowledgement (HARQ-ACK); and
transmitting, to the network device, the Msg3 message comprising the UL-CCCH-Message message including the RRCSetupRequest message having the HARQ-ACKRepetitionCapability field set to the value of 1.

42. The method of claim 41, wherein the terminal device is a non-reduced capability terminal device, and wherein the CCCH message comprises the UL-CCCH-Message message rather than a UL-CCCH1-Message message.

43. The method of claim 42, wherein the RRCSetupRequest message is a 48-bit RRC message within the UL-CCCH-Message message.

44. The method of claim 43, wherein the UL-CCCH-Message message is included in a common control channel service data unit (CCCH SDU), and wherein the CCCH SDU is included in a medium access control protocol data unit (MAC PDU) with a MAC subheader associated with the CCCH SDU.

45. The method of claim 44, wherein the MAC subheader is placed in front of the CCCH SDU in the MAC PDU.

46. The method of claim 44, wherein the MAC subheader comprises two one-bit reserved fields and a six-bit logical channel identifier (LCID) field.

47. The method of claim 46, wherein the configuration received via the system information block comprises a mapping in which a value of 0 of the HARQ-ACKRepetitionCapability field indicates that the terminal device is not capable of HARQ-ACK repetitions, and the value of 1 of the HARQ-ACKRepetitionCapability field indicates that the terminal device is capable of HARQ-ACK repetitions.

48. The method of claim 47, wherein the PRACH signal initiates a random access channel procedure, and wherein the Msg2 message schedules the Msg3 message for transmission of the RRCSetupRequest message.

49. The method of claim 48, wherein the terminal device sets the one-bit spare subfield to the value of 1 only when the terminal device supports coverage enhancements and is operating in the NTN while performing the uplink compensation according to the information received in SIB19.

50. The method of claim 49, wherein an EstablishmentCause field of the RRCSetupRequest message includes a plurality of spare states, and wherein the one-bit spare subfield of the RRCSetupRequest-IEs field indicates that the EstablishmentCause field is to be re-interpreted for coverage enhancement signaling.
